(19) United States
(12) Patent Application Publication
(10) Pub. No.: US 2023/0068237 A1
(43) Pub. Date: Mar. 2, 2023

(54) GRIPPER TOOLS FOR OBJECT GRASPING, MANIPULATION, AND REMOVAL

(71) Applicant: APPHARVEST TECHNOLOGY, INC., Morehead, KY (US)

(72) Inventors: Ryan R. Knopf, Melrose, MA (US); Jason A. Chrisos, Somerville, MA (US); Joshua Aaron Lessing, Cambridge, MA (US); Ryan Wasserman, Woburn, MA (US)

(21) Appl. No.: 17/759,541

(22) PCT Filed: Mar. 2, 2021
(86) PCT No.: PCT/US2021/020476

§ 371 Date: Jul. 27, 2022

Related U.S. Application Data
(60) Provisional application No. 62/984,125, filed on Mar. 2, 2020.

(51) Int. Cl. A01D 46/30; B25J 9/16; B25J 19/02; G06T 7/00; G06T 7/60; G06T 7/70

(52) U.S. Cl. CPC A01D 46/30; B25J 9/1612; B25J 9/1697; B25J 19/023; G06T 7/0012; G06T 7/60; G06T 7/70; G06T 2207/30188

(57) ABSTRACT

Disclosed herein is a collection tool configured to independently grasp and cut a tether of a target object for removal from an environment. The collection tool may include a body securable to a robotic arm of a collection robot, a base secured to the body, a plurality of fingers having proximal ends attached to the base, the plurality of fingers constructed and arranged to grasp the target object at distal ends of the plurality of fingers, and a blade coupled to one of the base or body and configured to cut the tether to which the target object is attached while the target object is held by the plurality of fingers.

### TECHNICAL FIELD

Aspects disclosed herein relate generally to robotic object grasping and manipulation.

### BACKGROUND

Agricultural technology is a sector of significant commercial interest. Examples of some emerging agricultural technologies pertain to automated farming tools for crop care and irrigation. Automation of harvesting operations poses significant challenges.

### SUMMARY

In accordance with one or more embodiments, a collection tool is disclosed. A collection tool may include a body securable to a robotic arm of a collection robot, a base secured to the body, a plurality of fingers having proximal ends attached to the base, the plurality of fingers constructed and arranged to grasp a target object at distal ends of the plurality of fingers, and a blade coupled to one of the base or body and configured to cut a tether to which the target object is attached while the target object is held by the plurality of fingers.

In some embodiments, the collection tool may further comprise a guide plate having apertures through which the plurality of fingers pass. Movement of the guide plate from a position proximate the proximal ends of the plurality of fingers to a position proximate the distal ends of the plurality of fingers may cause the plurality of fingers to close around the target object. In some embodiments, a profile of curvature of the plurality of fingers acts as a cam/follower mechanism, converting linear extension of the guide plate to transverse grasping force on the target object.

In some embodiments, the collection tool may further comprise a linear actuator including a shaft coupled to the guide plate and configured to drive the guide plate back and forth along the plurality of fingers.

In some embodiments, the blade is mechanically secured to guide plate and is configured to engage and cut the tether as the guide plate reaches the proximal ends of the plurality of fingers. For example, the blade is fixedly secured to the guide plate.

In certain embodiments, the blade is disposed on a distal end of a rod passing through a bushing in the guide plate, the bushing providing for free movement of the rod through the guide plate, a spring disposed about the rod between a spring stop at a proximal end of the rod and a surface of the guide plate on a side of the guide plate opposite a side of the guide plate facing the blade. In further embodiments, the collection tool includes a counterweight coupled to the proximal end of the rod. In some embodiments, the collection tool may further comprise a latch configured to hold the rod in a retracted position in which the spring is compressed while the guide plate moves from the position proximate the proximal ends of the plurality of fingers to the position proximate the distal ends of the plurality of fingers. The latch may be further configured to release the rod and cause the blade to move, driven by the spring returning to an unexpanded state, into position to cut the tether responsive to the guide plate reaching the position proximate the distal ends of the plurality of fingers. In some embodiments, the collection tool may further comprise a hard stop on the guide plate configured to engage the rod and return the rod to the retracted position as the guide plate moves from the position proximate the distal ends of the plurality of fingers to the position proximate the proximal ends of the plurality of fingers.

In some embodiments, the blade is secured to a distal end of a shear bar having a proximal end fixedly secured to the body. In some embodiments, the base is configured to rotate to bring the tether of the target object, while the target object is held by the plurality of fingers, into contact with the blade and to apply sufficient rotational force to the target object that the blade cuts the tether. In some embodiments, the shear bar has a bifurcated profile. In some embodiments, the shear bar includes a fixed beam, a bifurcated head, and a pivot coupling the bifurcated head to the fixed beam. In some embodiments, the shear bar includes a hooked distal end.

In further embodiments, the collection tool includes a bar having a proximal end fixedly secured to the body and a distal end configured to move and/or stabilize a position of the tether. In some embodiments, the distal end of the bar includes a resilient material. In some embodiments, the blade is fixedly secured to the body.

In certain embodiments, a grasping assembly including the base and plurality of fingers is configured to move away from the body, capture the target object in the plurality of fingers while the base is disposed away from the body, and to retract back to the body with the target object secured in the plurality of fingers, retracting of the grasping assembly back to the body causing the tether to come into contact with and be cut by the blade.

In some embodiments, the blade is rotationally secured to the body. The collection tool may further include an actuator configured to cause the blade to rotate relative to the body and come into contact and cut the tether while the target object is secured in the plurality of fingers. In some embodiments, the plurality of fingers is arranged in an elongated rectangular configuration. In some embodiments, the plurality of fingers is arranged in an asymmetric cross pattern.

In further embodiments, the collection tool may include a vision system configured to: capture an image of the target object, calculate a size of the target object from the image, an determine if the target is ready for collection by comparing the calculated size to a threshold size. In some embodiments, the size is a length of the target object. In some embodiments, the size is a circumference of the target object. In certain embodiments, the vision system may be further configured to determine a location at which the tether should be cut based on an analysis of the image.

In accordance with one or more aspects, a method of collecting a target object utilizing the collection tool as described herein is disclosed. The method may comprise enveloping the target object with the plurality of fingers on the collection tool, grasping the target object with the plurality of fingers on the collection tool, cutting the tether of the target object, and removing the target object from a surrounding environment.

In some embodiments, the method may further comprise identifying and/or locating the target object. In some embodiments, the method may further comprise assessing ripeness of the target object. Ripeness may be assessed by a size of the target object. In some embodiments, the size is a length of the target object. In some embodiments, the size is a circumference of the target object. The size of the target object may be measured using a vision system comprising a camera. In some embodiments, the measured size is compared to a predetermined threshold size. In certain embodiments, an identified location and the measured size of the target object is used to determine a location for cutting the tether of the target object. In some embodiments, environmental obstructions are substantially avoided. In some embodiments, grasping of the target object is performed independently of cutting of the tether of the grasped target object. In further embodiments, the method may comprise releasing and/or delivering the target object to a downstream process.

In accordance with one or more aspects, a collection system is disclosed. The collection system may include a robotic arm and the collection tool as described herein operatively attached to the robotic arm.

In some embodiments, the collection system may further comprise a controller programmable to operate the robotic arm and/or the collection tool. In some embodiments, the collection system may further comprise a vision system programmable to identify and/or locate a target object by capturing an image of the target object. In some embodiments, the vision system may be further configured to calculate a size of the target object from the image. The vision system may be further configured to determine if the target is ready for collection by comparing the calculated size to a threshold size. In some embodiments, the size is a length of the target object. In some embodiments, the size is a circumference of the target object. The vision system may be further configured to determine a location at which the tether should be cut based on an analysis of the image. In further embodiments, the robotic arm may be configured to release and/or deliver the target object to a downstream process.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 presents a schematic of the general steps of processing a target object in accordance with one or more embodiments;

FIGS. 2A-2B illustrate the grasping of different shaped target objects using a collection tool in accordance with one or more embodiments;

FIG. 3 presents an isometric view of a collection tool in accordance with one or more embodiments;

FIGS. 4A-4C illustrate the steps of processing a target object using a collection tool in accordance with one or more embodiments; FIGS. 5A-5B present views of a collection tool having a rotating base in accordance with one or more embodiments;

FIGS. 6A-6B present views of a collection tool having a rotating shear bar in accordance with one or more embodiments;

FIGS. 7A-7E present different embodiments of shear bars for a collection tool in accordance with one or more embodiments;

FIGS. 8A-8P present different cross-sectional shapes for shear bars for a collection tool in accordance with one or more embodiments;

FIGS. 9A-9B present views of a collection tool having an actuated shear bar in accordance with one or more embodiments; FIG. 10 illustrates the steps of processing a target object using a collection tool in accordance with one or more embodiments;

FIG. 11 presents an overview schematic of a robotic target object collection system, according to one or more embodiment; and

FIG. 12 illustrates the calculation used to determine when a target object is to be grasped and removed in accordance with one or more embodiments.

### DETAILED DESCRIPTION

Many types of agricultural produce will not release from the vine when only grasped and pulled or twisted. These produce items are typically manually harvested with hand shears, so that workers can reduce disruption to the vines while harvesting. Mechanical and robotic harvesting systems that work on these types of crop may be equipped to mechanically shear the vine connecting the fruit to the main trunk of the vine. By employing a mechanism dedicated to shearing the vine or shearing the vine in concert with other robotic manipulator motions, a robotic harvesting system can achieve higher throughputs and picking coverages by cleanly shearing the vine at the site of the produce growth. A dedicated shearing, i.e., cutting, element ensures that the motion imparted to the vine due to harvesting will result in the least possible vine sway, which in turn reduces the time until the next pick can be attempted, thus boosting possible harvesting throughput. In addition, clean vine severance is desired because anywhere a vine has been cut is an open wound—vine tears rarely heal as completely or as quickly as clean sheared cuts. By reducing vine swinging and creating clean, healable cuts, increased throughput and yield for a robotically harvested crop may be achieved.

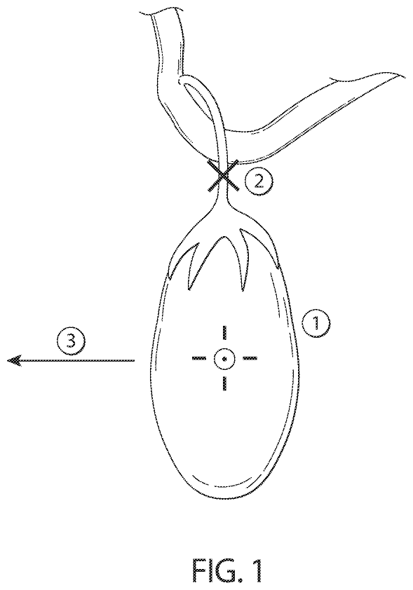

In accordance with one or more embodiments, a target object may be strategically grasped and manipulated, for example, to facilitate collection, e.g., harvesting, thereof. In some embodiments, a target object may be picked in place, i.e., from a target surface or a target location. In at least some embodiments, the target object may be grasped, and a portion thereof, such as a tether, cut or sheared so as to remove the target object in place. In various embodiments, a grasped and/or dislodged target object may be removed from an environment, i.e., an agricultural environment. In at least some embodiments, a tool may be configured to independently grasp and shear a portion of the target object. FIG. 1 shows a general schematic of the steps for removal of a tethered target object by shearing a portion of the target object. As depicted in steps 1-3 of FIG. 1, a target object may be conformally grasped such that it is secured in position, the tether location sheared to dislodge the target object from the tether, and removed from the environment into an outbound material stream. A “tether,” as used herein, refers to a stem or vine of an article of agricultural produce. The same actuation mechanism may be used to accomplish a wide variety of motions, force application profiles, and handling of different target objects via select interchangeable components. Beneficially, the number of components in contact with the target object may be minimized to facilitate cleaning and to promote sanitized operation. The tools described herein can be constructed of materials compatible with various industry and regulatory safety standards.

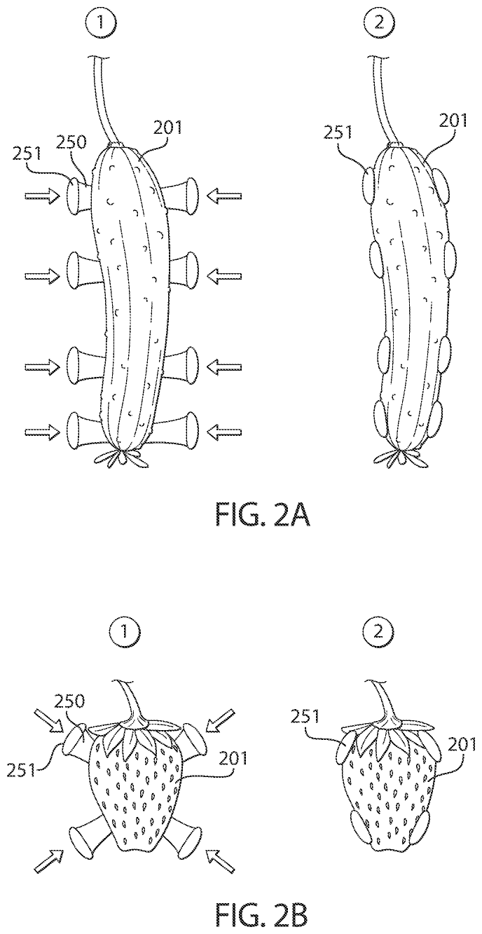

In accordance with one or more embodiments, a wide variety of target objects may serve as an intended workpiece. Target objects may vary in terms of their size, geometry, firmness, and various other properties. In some embodiments, the target object may generally be characterized as delicate or otherwise easily crushable. In at least some embodiments, the target object may pertain to agricultural produce, e.g., the target object may be agricultural produce, i.e., a fruit or a vegetable. In some specific non-limiting embodiments, the target object may be a strawberry or an elongate vegetable, such as a cucumber, eggplant, pepper, or gourd, e.g., a yellow squash. For example, FIG. 2A illustrates a cucumber as a target object 201 being grasped by eight fingers 250 arranged vertically in pairs along the length of the cucumber and FIG. 2B illustrates a strawberry as a target object 201 being grasped by four fingers 250 arranged in an asymmetric cross pattern.

In accordance with one or more embodiments, a target object may be present in a variety of environments or settings. In some embodiments, the target object may be in an agricultural environment. In other embodiments, the target object may be in an industrial environment. The environment or setting of the target object may be indoors or outdoors. In some embodiments, the target object may generally be loose in the target environment. In other embodiments, the target object may be attached or tethered such as to a host in the target environment. For example, a target object may pertain to agricultural produce on a plant, e.g., a vine or stem, for ripening.

In accordance one or more embodiments, a collection tool may be used to perform one or more of the following functions with respect to a target object: grasping, dislodgment, and/or removal. A target object may be enveloped and grasped. Alternatively, a target object may be partially enveloped when grasped. In some embodiments, a grasped target object may generally be dislodged via shearing or cutting portion of the target object from where it is tethered. For example, a target object may be a strawberry or a cucumber on a vine as shown in FIGS. 2A-2B. The strawberry or cucumber may be grasped and dislodged from the calyx of the vine by shearing or cutting the vine.

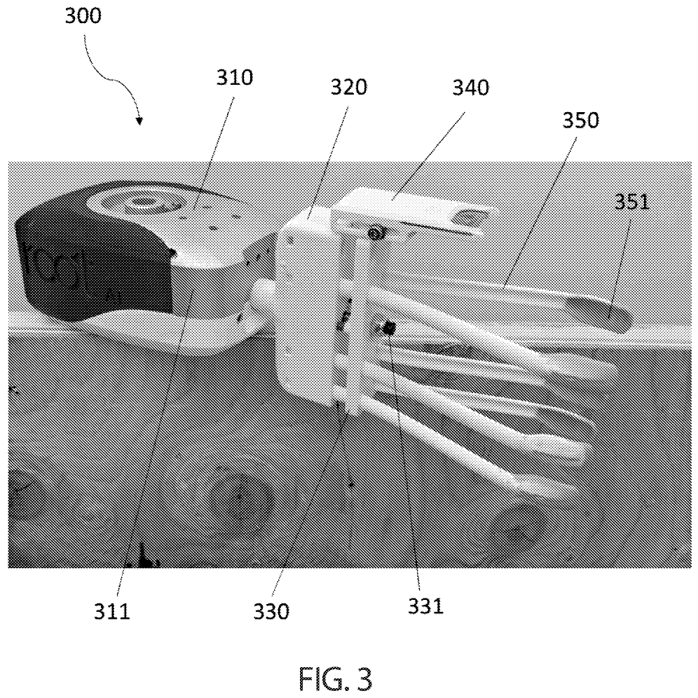

In accordance with one or more embodiments, a collection tool may generally include a body securable to a robotic arm of a collection robot. A base having a plurality of fingers having proximal ends attached to the base may be secured to the body. The plurality of fingers may be constructed and arranged to envelop a target object at distal ends of the plurality of fingers. The collection tool may further include a blade coupled, directly or indirectly, to the base or body and configured to cut or shear a tether to which the target object is attached while the target object is held by the plurality of fingers. In some embodiments, the base may be configured to rotate relative to a first position. For example, the base may be configured to rotate up to 90° from a first position. The collection tool may be interchangeable so as to accommodate target objects of varying sizes and/or requirements. An example of a collection tool having a base, a plurality of fingers, and a blade is shown in FIG. 3. In FIG. 3, collection tool 300 includes body 310 with a linear actuator 311 connected to base 320 having a plurality of fingers 350 extending from the base. The plurality of fingers pass through apertures in guide plate 330 connected to linear actuator 311 by shaft 331 which includes blade 340 connected to an upper surface of the guide plate 330 using a mechanical fastener that permits adjustment of the blade position. Each of the plurality of fingers 350 has at its distal end a wider feature 351 configured to provide a secure conformal grip around a target object when engaged.

In accordance with one or more embodiments, a collection tool may include a guide plate having apertures through which the plurality of fingers pass. The guide plate, when moved from a position proximate the proximal ends of the plurality of fingers to a position proximate the distal ends of the plurality of fingers, causes the plurality of fingers to close around the target object. The guide plate may be actuated, i.e., back and forth, along the plurality of fingers by the actuation of a linear actuator. The shaft of the linear actuator may be coupled to the guide plate by any suitable connection, such as a mechanical fastener or chemical fastener, such as illustrates in FIGS. 3-6B, 9A, 9B, and 10.

In accordance with one or more embodiments, the plurality of fingers may have a curved profile. The curvature of the plurality of fingers may be configured to act as a cam/follower mechanism. In this configuration, when the guide plate is actuated along the plurality of fingers, the linear motion is converted into a transverse motion at the distal ends of the plurality of fingers, causing the plurality of fingers to close around a portion of the target object. In some embodiments, the plurality of fingers may be jointed to facilitate grasping of the target object. In other embodiments, the plurality of fingers may be contoured to facilitate grasping of the target object. In at least some embodiments, the plurality of fingers may include a conformable feature and/or an engagement surface to facilitate grasping of the target object. As illustrated in FIGS. 2-6B, the distal ends 251, 351, 451, 551, and 651 of the plurality of fingers 250, 350, 450, 550, and 650 may include a feature that is wider and more pliable than portions of the plurality of fingers 650 near the proximal ends or middle portions and that facilitates secure conformal contact on the target object. Such a feature may also provide a forward surface capable of a palming grasp on the target object. In some non-limiting embodiments, a palming grasp may be a frictional grasp. In some embodiments, a palming grasp may involve grasping less surface area of a target object than that involved with an enveloping grasp. In at least some embodiments, a palming grasp may involve grasping less than half of the surface area of a target object. The plurality of fingers may include any number of fingers, e.g., one, two, three, four, five, six or more fingers, and the number of fingers may be selected based on one or more physical properties of the target object to be collected, such as a length or width of the target object. The plurality of fingers may be arranged on the base in any pattern suitable for grasping the desired target object and the profile of curvature and opening size may generally correlate to the size of a target object where the plurality of fingers are arranged in a layout that corresponds to the expected contour or shape of the target object being collected. In some embodiments, it may be desirable to minimize the opening size or cross-section associated with the plurality of fingers in order to prevent disruption of the environment. In some non-limiting embodiments, the plurality of fingers may be arranged in a vertical orientation along parallel or opposing sides of the base, that is, an elongated rectangular configuration; examples of this arrangement are illustrated in FIGS. 2A and 3-6B. In this configuration, the collection tool may be configured to grasp an elongate target object, with the plurality of fingers contacting the elongate target object along its length. Upon closure of the plurality of fingers by displacing the guide plate towards the distal ends of the plurality of fingers, each finger, by virtue of having been pre-arranged in an elongated rectangular configuration, is able to make nearly perpendicular contact with the surface of the target object. Since the plurality of fingers are each compliant and able to flex independently, the plurality of fingers conform to any curves or irregularities in the shape of the target object. In other non-limiting embodiments, the plurality of fingers may be arranged in an asymmetric crossed pattern along parallel or opposing sides of the base; an example of this arrangement is illustrated in FIG. 2B. In this configuration, the collection tool may be configured to conformally grasp a target object with a smaller and/or more bulbous profile, such as the rounded heart-shaped profile of a strawberry or other similarly shaped target object. Independent of the shape, this level of conformality is sufficient to adapt to the subtle but infinitely variable shapes that naturally occurring target objects, such as fruits and vegetables, have within the same varietal or species. A skilled artisan can appreciate that the orientation and number of fingers attached to the base may depend on the physical properties of the target objects that need to be manipulated and any number of alternate configurations of the plurality of fingers may be contemplated without departing from the spirit of the invention.

In accordance with one or more embodiments, the blade of the collection tool may be mechanically secured to guide plate. As the guide plate is actuated linearly along the length of the plurality of fingers by the linear actuator, the blade may be configured to engage and cut the tether of the target object, such as a vine or stem, as the guide plate approaches or reaches the proximal ends of the plurality of fingers. In some embodiments, the blade may be fixedly secured to the guide plate using any suitable mechanical fastener, such as a nut and bolt or similar. In this configuration, the position of the blade relative to the guide plate may be adjusted such that the blade can engage the tether of the target object; a skilled artisan can appreciate that the position of the blade relative to the guide plate may be different for target objects of varying dimension. An example of a blade 340 fixedly secured to the guide plate 330 is illustrated in FIG. 3 where the position of the blade 340 relative to the guide plate 330 is adjustable by a mechanical fastener, e.g., a set screw, on the blade housing. In use, a fixedly secured blade is configured to shear or cut the tether only after the target object is grasped by the plurality of fingers and the guide plate advanced along the length of the plurality of fingers.

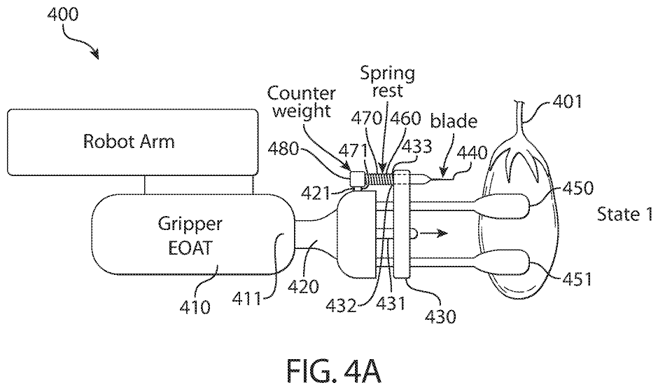

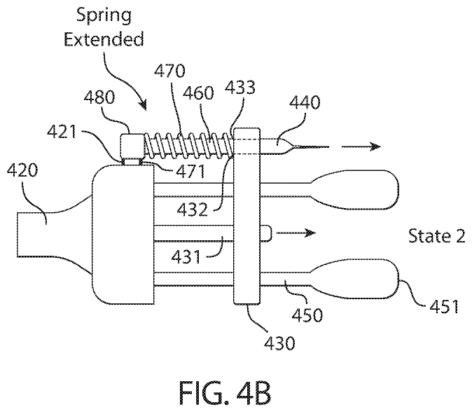

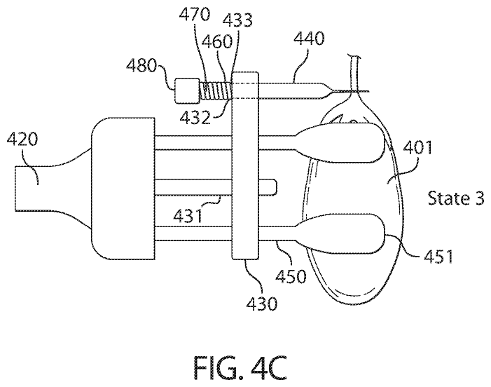

In accordance with one or more embodiments, the blade of the collection tool may be disposed on a distal end of a rod passing through a bushing in the guide plate. A schematic of this embodiment is illustrated in FIGS. 4A-4C showing a tool 400 having body 410 with linear actuator 411, base 420, guide plate 430 including a bushing 432 connected to linear actuator 411 by rod 431, and a plurality of fingers 450. In this configuration, the bushing 432 of the guide plate 430 provides for free or unrestricted movement of the rod 460 through the guide plate. A spring 470 having a spring stop 471 may be disposed about the rod 460 between a spring stop at a proximal end of the rod 460 and a surface of the guide plate 430 on a side of the guide plate 430 opposite a side of the guide plate 430 facing the blade 440. The rod 460, at its distal end, may include a counterweight 480 that is of a mass sufficient to assist in storing the energy of the spring 470 disposed about the rod 460. The rod 460 may be held in a retracted position, i.e., when the spring 470 is compressed, by a latch 421 as the guide plate 430 moves from the position proximate the proximal ends of the plurality of fingers 450 to the position proximate the distal ends of the plurality of fingers 450. Once secured in the retracted position, the latch 421 may be configured to release the rod 460 and cause the blade 440 to move, driven by release of the spring 470, into position to cut the tether of the target object 401 responsive to the guide plate 430 reaching the position proximate the distal ends of the plurality of fingers 450. Actuation of the guide plate 430 allows the high inertia of the counterweight 480 to cause the spring 470 to extend and store potential energy and to then release its stored potential energy, propelling the counterweight 480, rod 460, and blade 440 forward and cleanly severing the tether of the target object 401. In some embodiments, a time-delay may beneficially ensure that the blade shears the tether only upon ensuring a proper grasp has been made on the target object. The collection tool may include a hard physical stop 433 on the guide plate 430 that is configured to engage the rod 460 and/or spring 470 and return the rod 460 to the retracted position as the guide plate 430 moves from the position proximate the distal ends of the plurality of fingers 450 to the position proximate the proximal ends of the plurality of fingers 450. A skilled artisan can appreciate that the amount of force applied to the blade 440 and the plurality of fingers 450 may be modified through spring 470 selection and counterweight 480 sizing, thus reducing the need to use the curvature profile of the fingers 450 to do so.

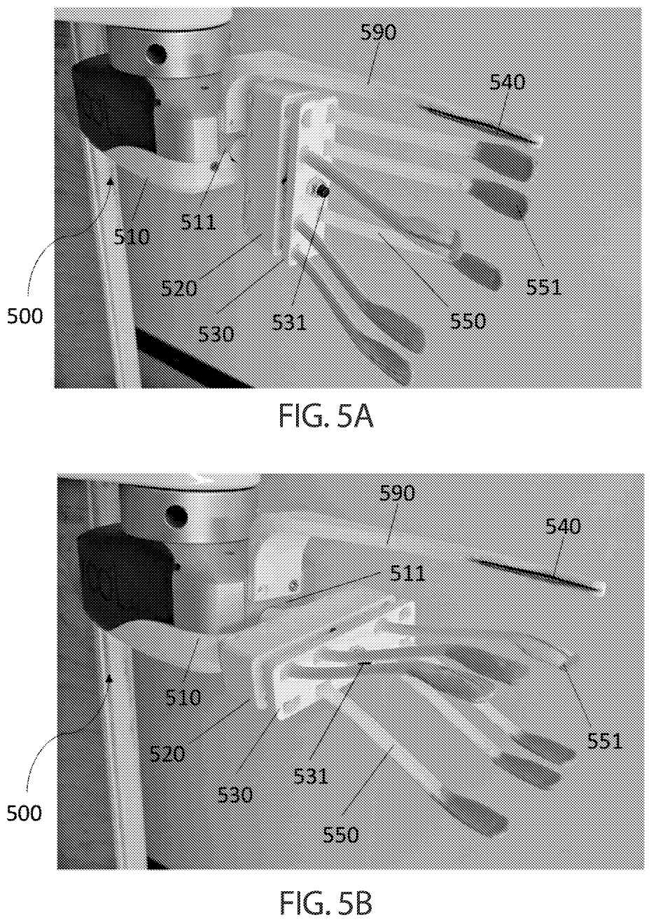

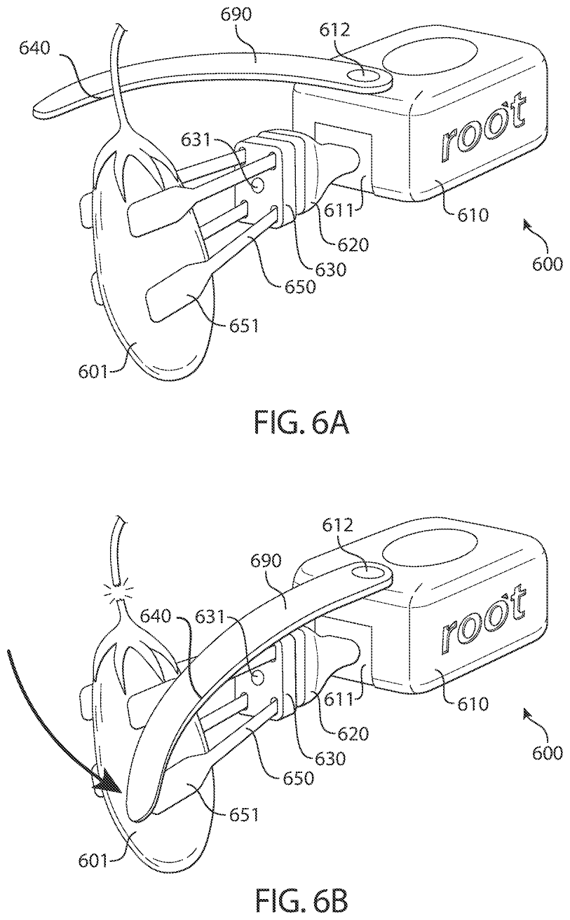

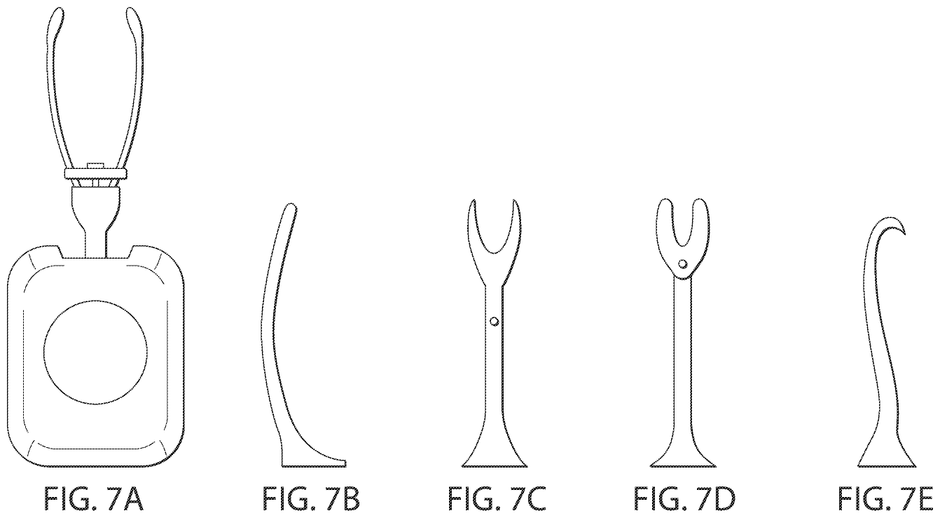

In accordance with one or more embodiments, the collection tool may include a shear bar that may be configured to shear or cut the tether of the target object when engaged by the plurality of fingers. The shear bar may have a blade or similar structure secured at its distal end; such embodiments are illustrated in FIGS. 5A, 5B, 6A, and 6B. With reference to FIGS. 5A, 5B, 6A, and 6B, the shear bar 590, 690 may have any suitable profile, and the profile may be chosen for specific target objects. Example shear bar profiles are illustrated in FIGS. 7B-7E, with FIG. 7A illustrating the collection tool without the shear bar installed. The shear bar illustrated in FIG. 7B has a curved profile and is configured to be offset to one side of the tether of the target object. This shear bar profile may be applicable to situations where the tether of the target object is structurally stable and does not require any steadying but requires a shearing mode for shearing or cutting. The shear bar illustrated in FIG. 7C has a bifurcated profile and is configured to envelop the sides of the tether. This shear bar profile may enhance tether stabilization, and its larger frontal cross-section is suited for shearing tethers in uncluttered environments. The shear bar illustrated in FIG. 7D has a bifurcated profile but includes a pivot point between the fixed beam and the bifurcated head such that it can move with the direction of the tether of the target object, thus enhancing guidance and stabilization of the tether with even less positional accuracy required to envelop the tether. The shear bar illustrated in FIG. 7E has a hooked distal end and may be used to shear a tether in a difficult to access environment, such as for an agricultural product that tends to grow underneath surrounding vegetative growth. The hooked distal end may be used to manipulate the target object to a location more suited for removal from the tether. The hooked distal end may also be used to manipulate obstructions located in the environment of the target object to move them out of the way of the target object to be collected.

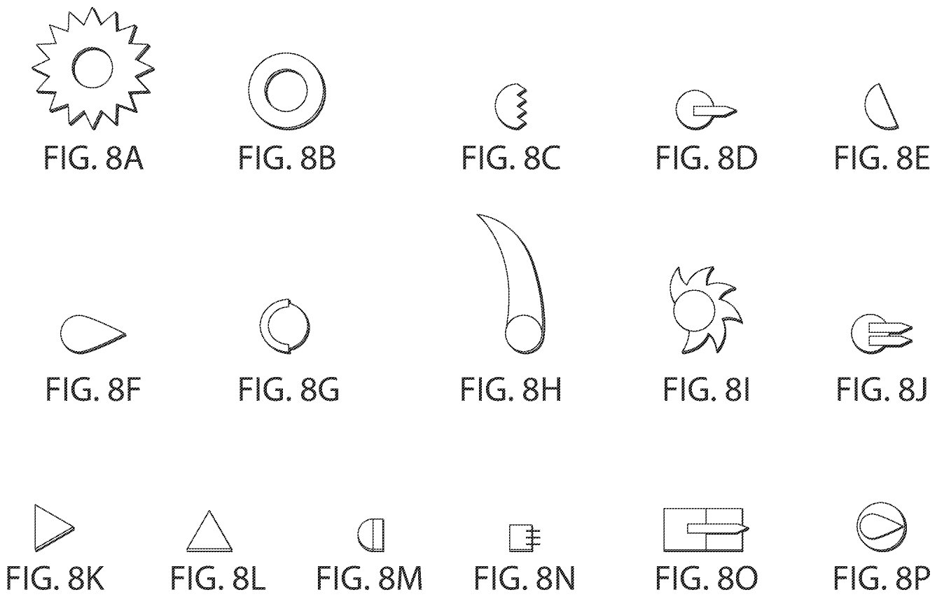

In some embodiments, the cross-sectional shape, i.e., the engagement surface, of the distal end of the shear bar may be adapted to be suited to shear or cut tethers of varying dimensions, properties, and locations. FIGS. 8A-8P illustrate various embodiments of distal end shapes. FIG. 8A illustrates a rigid core encapsulated by a textured resilient material, such as an elastomer. The design illustrated in FIG. 8A maximizes the surface area of resilient material in contact in any direction with a target object, for example, for sparsely arranged fruit with more durable vine support. FIG. 8B illustrates a rigid core encapsulated with a smooth coating of a resilient material configured to minimize frontal penetrating cross section into dense vegetation that requires less grip on the vine surface during the shearing action. The cross-section illustrated in FIG. 8C is rigid with triangular ridges, where grip is generated on the tether through mild abrasion during the shearing of the tether. The rigid and ridged cross-section provides increased durability compared to a surface having a resilient member and may be useful for tethers that are woodier and more brittle. FIG. 8D illustrates a cross-section of a rigid shearing bar supporting a sharpened metal cutting blade, and is most effective for target objects that have softer tether surfaces with high tether tensile strength. FIG. 8E illustrates a blunt shearing version of a rigid construction. FIG. 8F illustrates a pointed teardrop shape of rigid construction configured to act similarly to a blade without using a second material. Both FIGS. 8E and 8F provide similar benefits compared to a sharpened cutting tool without the intrinsic hazards and cost of such.

FIG. 8G illustrates a C-profile beam shape that is infilled with a resilient material. This construction provides an energy dampening property that may reduce the vibratory energy in the shear bar as it is cantilevered out of a motion system while simultaneously using the grip properties of the resilient material to accomplish a shearing force during twist. The embodiment illustrated in FIG. 8H uses a large vertical fin of resilient material to generate very high surface contact with a tether and absorb the tether swinging energy during the approach to the target object to improve targeting efficacy. FIG. 81 illustrates a rigid structure having a portion surrounded by a textured resilient material. A structed of this type may be used by the robotic system either as a low grip surface for tether manipulation movements or a high grip surface for tether shearing when engaged to either side by the robot system's overall motion. FIG. 8J illustrates a rigid structure with dual embedded cutting blades similar to FIG. 8D, where the spacing and relative heights of the two blades can further tune the shear and grip properties of the cutting tool to the physical properties of the tether. FIGS. 8K and 8L represent variations on blunt shearing profiles such as the profile depicted in FIG. 8E. FIG. 8M illustrates a rigid semicircular member with a rectangular profile resilient material surface. FIG. 8N illustrates a rectangular profile rigid beam containing multiple sharp cutting elements. FIG. 8O illustrates a rigid bar supporting a sharpened cutting element embedded in a resilient material. The multi-material construction allows the blade surface to be concealed when pressure is not applied to the resilient material, reducing unintentional snags on tethers. FIG. 8P illustrates a teardrop rigid structure similar to the profile depicted in FIG. 8F that is encapsulated by a resilient material. In some cases, different engagement surfaces of the shear bar may be chosen for specific needs, such as the simplicity of manufacture, reducing hazards from the presence of an open blade on a moving system, reducing the requirements for cleaning and/or maintenance, or to pull the tether of the target object rather than shear or cut it.

In accordance with one or more embodiments, the proximal end of the shear bar may be fixedly secured to the body of the tool. In this configuration, the base of the tool is configured to rotate after grasping the target object with the plurality of fingers such that the tether of the target is brought into contact with the distal end of the shear bar. The rotation of the base of the tool having a fixed shear bar is illustrated in FIGS. 5A-5B following the same labeling scheme as FIG. 3. FIG. 5A illustrates the position of the body 510 with linear actuator 311, base 520 with guide plate 530 connected to linear actuator 511 by rod 531, and the plurality of fingers 550 relative to the fixed shear bar 590 with blade 540 and FIG. 5B illustrates the position of the base 520 and the plurality of fingers 550 relative to the fixed shear bar 590 with blade 540 after rotation of the base by 90°. The rotation of the base 520 of the tool 500 may apply sufficient rotational force, i.e., torque, to the target object to allow the blade 540 of the shear bar 590 to shear or cut the tether. The shearing mechanism may provide from 10 mN-m to 1.5 N-m of torque to the target object. For example, the shearing mechanism may provide from 10 mN-m to 100 mN-m, 50 mN-m to 500 mN-m, 250 mN-m to 750 mN-m, 500 mN-m to 1.0 N-m, or 750 mN-m to 1.5 N-m of torque to the target object. A skilled artisan can appreciate that the amount of torque provided may depend on the mechanical properties of the target object to be collected. Alternatively, the shear bar having a blade may be rotationally secured to the body of the tool; this embodiment is illustrated in FIGS. 6A-6B following the same labeling scheme as FIGS. 3, 5A, and 5B. FIG. 6A illustrates the position of the rotatable shear bar 690 with blade 640 relative to a grasped tethered target object 601, shown as an eggplant on a vine. In this configuration, the tool 600 includes an actuator 612 that allows the shear bar 690 with blade 640 to rotate relative to the body 610 including linear actuator 611, base 620, and guide plate 630 connected to linear actuator 611 by rod 631 and come into contact and cut the tether of the target object 601 while it is secured in the plurality of fingers 650. As illustrated in FIG. 6B, the rotation of the shear bar 690 with blade 640 along the arrow allows blade 640 of the shear bar 690 to cut the tether of the target object 601. The rotation of the shear bar 690 is of sufficient torque and/or velocity such that blade 640 of the shear bar 690 can shear or cut the tether. The velocity of the rotating shear bar may be dependent on the mechanical properties of the tether and the design and shape of the shear bar. Higher velocities of the shear bar may improve performance against brittle tethers and against tougher and/or more durable tethers when fitted with a cutting blade. Using the lowest effective velocity is desirable to reduce disturbance to the environment. Combining an equal gripping assembly twisting velocity with an opposed direction shear bar impact may negate any motive energy the shearing motion may normally impart to the tether. The cutting force of the rotating shear bar is not correlated to the physical dimensions of the target object that is tethered and further reduces unnecessary motions imparted to the tether and its surrounding environment. A skilled artisan can appreciate that the rotational force of either the base of the tool or the shear bar mar be adjusted for tethers or target objects of varying physical dimensions.

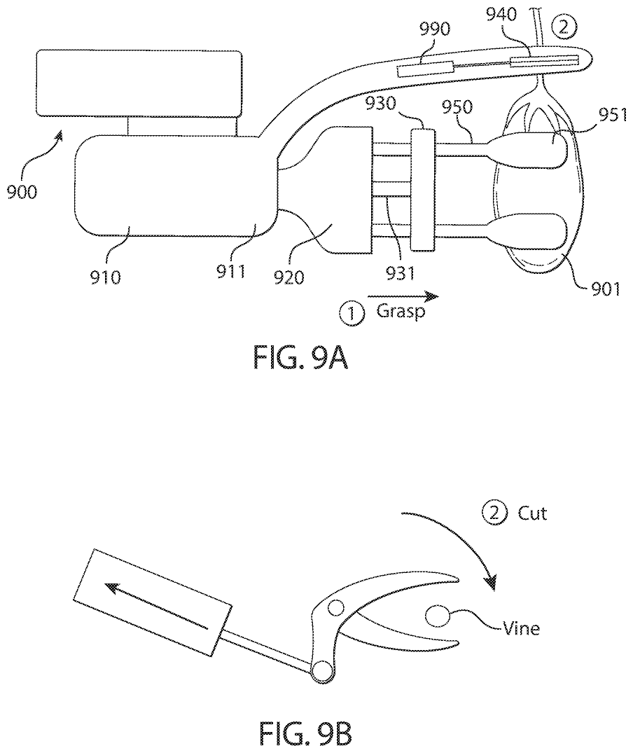

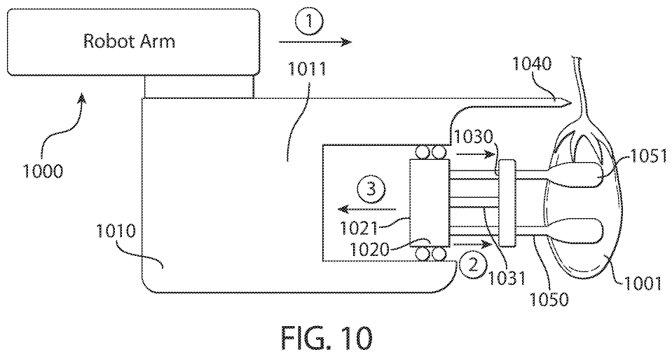

In accordance with one or more embodiments, a collection tool may include an actuator, separate from the actuator of the body that closes the plurality of fingers, that is connected to the shear bar and configured to directly actuate the shear bar to shear or cut the tether of the target object. This embodiment is illustrated in FIGS. 9A-9B following the same labeling scheme as FIGS. 3, 5A, 5B, 6A, and 6B. In FIG. 9A, the tethered target object 901, shown as an eggplant on a vine, is grasped by a tool 900 having a body 910 including linear actuator 911, base 920, guide plate 930 connected to linear actuator 911 by rod 931, and a plurality of fingers 950, 951 by extension of the guide plate 930 along the length of the plurality of fingers 950, 951. The tool 900 is moved into a position that enables the tether to be brought into contact with the shear bar 990 with blade 940. In the top-down view of shear bar 990 with blade 940 and tether illustrated in FIG. 9B, the shear bar 990 includes a bifurcated head where one of the bifurcations is pivoted to act as blade 940. The pivoted bifurcation is connected to the actuator and can be closed against the fixed bifurcation to shear to cut the tether. In this configuration, the separately actuated shear bar 990 may be able to achieve high shear forces as to enable it to shear or cut through more durable tethers while maximizing time to process the target object 901 and minimizing spatial disturbances to the environment around the target object 901.

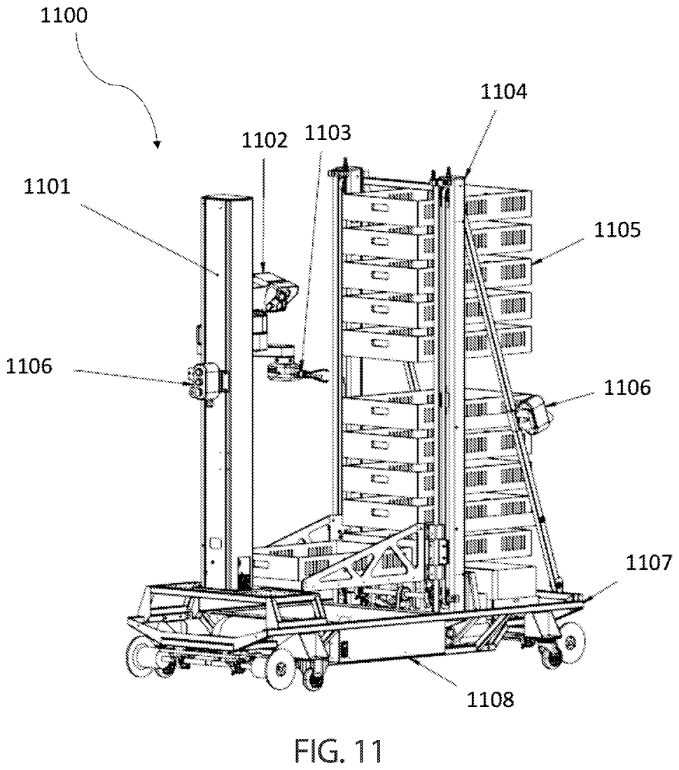

In accordance with one or more embodiments, a collection tool may include a blade fixedly secured to the body of the tool and a translatable grasping assembly. FIG. 10 illustrates such as embodiment. The tool 1000 has a grasping assembly that includes the base 1020 having linear actuator 1021, guide plate 1030, and the plurality of fingers 1050 and is configured to move linearly back and forth along the body 1010 of the tool 1000. The robotic arm approaches a target object 1001 to be collected in step 1 of FIG. 10 to a distance sufficient for the grasping assembly to reach the target object 1001. As the grasping assembly moves and is disposed away from the body 1010 of tool 1000 by liner actuator 1011, the plurality of fingers 1050 are actuated by the linearly actuated guide plate 1030 and grasp the target object 1001 using the wider portion of the 1051 of the plurality of fingers 1050, shown as step 2 in FIG. 10. When the target object 1001 is secured by the plurality of fingers 1050, the base 1020 and grasped target object 1001 are retracted back to the body 1010 of the tool 1000 by linear actuator 1011, allowing the tether of the target object 1001 to contact and be sheared or cut by the fixed blade 1040, shown as step 3 in FIG. 10. In accordance with one or more embodiments, a collection tool may be removably receivable by a robotic arm, such as robotic arm 1101 illustrated in FIG. 11. The robotic arm 1101 having a collection tool 1103 may be attached to a robotic carriage 1107 or a robotic manipulator as part of a robotic target object collection system 1100 having additional components, such as a vision system 1102, target object tray system 1104, 1105, manual operation controls 1106, and controller 1108 that programmable to operate the robotic arm and/or the collection tool. For example, a robotic arm and/or a guide plate and plurality of fingers of a collection tool may be strategically operated at variable speeds.

In accordance with one or more embodiments, a collection system may be programmed to operate a robotic arm and/or collection tool according to customizable routines. For example, in some non-limiting embodiments, a collection system may sequentially envelop, grasp, detach, and remove a target object from an environment.

In some embodiments, a robotic collection system may include at least one sensor associated with a collection tool, robotic arm, and/or other component. In some embodiments, the robotic arm may be further configured to release and/or deliver the target object to a downstream process. In accordance with one or more embodiments, a robotic manipulator may allow for customized motion, travel, and/or force profiles during actuation of a related robotic arm and/or collection tool. In at least some embodiments, a robotic manipulator may be calibrated.

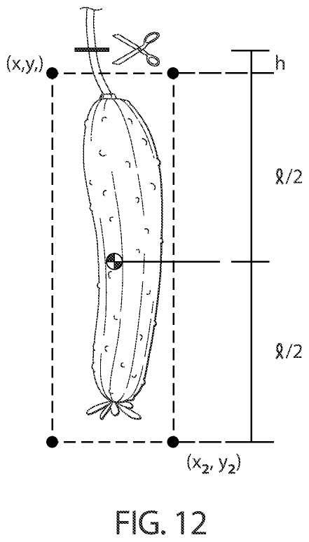

In accordance with one or more embodiments, a target object may be identified, located, and/or characterized. For example, a target object may be identified by ripeness. Ripeness of many target objects, such as fruits and vegetables, may be assessed by their color. For example, tomatoes, strawberries and peppers may exhibit a color change as they ripen. In some examples, ripening is not indicated by color changes. For those target objects that do not change colors when they ripen, such as cucumbers, a vision system, illustrated as 1102 in FIG. 11, may first capture an image of the target object and determine a two-dimensional bounding box within the image which most closely contains the outline of the target object. Using the coordinates of this box (labeled via points (x₁,y₁) and (x₂,y₂) as illustrated in FIG. 12), a centroid location for the target object may be calculated geometrically and a size or characteristic dimension, for example a length 1, of the target object can be calculated. The distance of the computer vision system to the target object can be measured, and this size or characteristic dimension in image pixels can be converted into a physical length. A threshold criterion may be applied to that size or characteristic dimension above which the proposed target object is considered ready “ripe,” that is, ready for collection. The threshold may be automatically determined via a machine learning training process where an operator trains the computer vision system using images of various target objects of known sizes or characteristic dimensions. Alternatively, or in addition, the threshold criterion may be manually fixed based on acceptable values that indicate the target object is ready for sale or distribution.

Once the size or characteristic dimension is known for a target object, this value may be used to automatically infer a location where the tether of the target object may be sheared or cut. Since the location of the blade or other cutting element is at a height relative to the center axis of the collection tool, which is known a priori, a constant height offset may be added to half the length, 1, to generate a location where the collection tool's cutting element should be deployed to cut the tether of the target object; this is illustrated as h in FIG. 12. In this configuration, the precise engagement height of the collection tool relative to the target object may be adjusted vertically to accommodate target objects of that vary in overall length while cutting the tether at the same relative location from the top of the target object. In accordance with one or more embodiments, the selection of a target object using the methods described herein may be performed by a controller programmable to operate a collection tool as described herein

In accordance with one or more embodiments, a collection tool as described herein may be utilized in a method of collecting a target object. The target object may be grasped with the plurality of fingers. The grasped target object may be brought towards a blade or shear bar to cut or shear a tether securing the target object. A blade or a shear bar may be brought towards the grasped target object to cut or shear a tether securing the target object. Grasping of the target object may be performed independently of cutting or shearing the tether of the grasped target object. The grasped target object may then be removed and/or released from the environment. For example, the target object may be released and/or delivered to a downstream process. The target objected may be enveloped, grasped, dislodged, and removed in series in some non-limiting embodiments. Environmental obstructions, i.e., other target objects, vines, and/or leaves, may be substantially avoided during the collection operation.

Having thus described several aspects of at least one implementation, it is to be appreciated various alterations, modifications, and improvements will readily occur to those skilled in the art. Such alterations, modifications, and improvements are intended to be part of this disclosure and are intended to be within the spirit and scope of the disclosure. The acts of methods disclosed herein may be performed in alternate orders than illustrated, and one or more acts may be omitted, substituted, or added. One or more features of any one example disclosed herein may be combined with or substituted for one or more features of any other example disclosed. Accordingly, the foregoing description and drawings are by way of example only.

The phraseology and terminology used herein is for the purpose of description and should not be regarded as limiting. As used herein, the term “plurality” refers to two or more items or components. As used herein, dimensions which are described as being “substantially similar” should be considered to be within about 25% of one another. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A collection tool comprising:
a body securable to a robotic arm of a collection robot;
a base secured to the body;
a plurality of fingers having proximal ends attached to the base, the plurality of fingers constructed and arranged to grasp a target object at distal ends of the plurality of fingers; and
a blade coupled to one of the base or body and configured to cut a tether to which the target object is attached while the target object is held by the plurality of fingers.

2. The tool of claim 1, further comprising a guide plate having apertures through which the plurality of fingers pass, movement of the guide plate from a position proximate the proximal ends of the plurality of fingers to a position proximate the distal ends of the plurality of fingers causing the plurality of fingers to close around the target object.

3. The tool of claim 2, wherein a profile of curvature of the plurality of fingers acts as a cam/follower mechanism, converting linear extension of the guide plate to transverse grasping force on the target object.

4. The tool of claim 3, further comprising a linear actuator including a shaft coupled to the guide plate and configured to drive the guide plate back and forth along the plurality of fingers.

5. The tool of claim 4, wherein the blade is mechanically secured to guide plate and is configured to engage and cut the tether as the guide plate reaches the proximal ends of the plurality of fingers.

6. The tool of claim 5, wherein the blade is fixedly secured to the guide plate.

7. The tool of claim 5, wherein the blade is disposed on a distal end of a rod passing through a bushing in the guide plate, the bushing providing for free movement of the rod through the guide plate, a spring disposed about the rod between a spring stop at a proximal end of the rod and a surface of the guide plate on a side of the guide plate opposite a side of the guide plate facing the blade.

8. The tool of claim 7, further comprising a counterweight coupled to the proximal end of the rod.

9. The tool of claim 7, further comprising a latch configured to hold the rod in a retracted position in which the spring is compressed while the guide plate moves from the position proximate the proximal ends of the plurality of fingers to the position proximate the distal ends of the plurality of fingers, and to release the rod and cause the blade to move, driven by the spring returning to an unexpanded state, into position to cut the tether responsive to the guide plate reaching the position proximate the distal ends of the plurality of fingers.

10. The tool of claim 9, further comprising a hard stop on the guide plate configured to engage the rod and return the rod to the retracted position as the guide plate moves from the position proximate the distal ends of the plurality of fingers to the position proximate the proximal ends of the plurality of fingers.

11. The tool of claim 4, wherein the blade is secured to a distal end of a shear bar having a proximal end fixedly secured to the body.

12. The tool of claim 11, wherein the base is configured to rotate to bring the tether of the target object, while the target object is held by the plurality of fingers, into contact with the blade and to apply sufficient rotational force to the target object that the blade cuts the tether.

13. The tool of claim 11, wherein the shear bar has a bifurcated profile.

14. The tool of claim 11, wherein the shear bar includes a fixed beam, a bifurcated head, and a pivot coupling the bifurcated head to the fixed beam.

15. The tool of claim 11, wherein the shear bar includes a hooked distal end.

16. The tool of claim 1, further comprising a bar having a proximal end fixedly secured to the body and a distal end configured to move and/or stabilize a position of the tether.

17. The tool of claim 1, wherein the distal end of the bar includes a resilient material.

18. The tool of claim 1, wherein the blade is fixedly secured to the body.

19. The tool of claim 18, wherein a grasping assembly including the base and plurality of fingers is configured to move away from the body, capture the target object in the plurality of fingers while the base is disposed away from the body, and to retract back to the body with the target object secured in the plurality of fingers, retracting of the grasping assembly back to the body causing the tether to come into contact with and be cut by the blade.

20. The tool of claim 1, wherein the blade is rotationally secured to the body.

21. The tool of claim 20, further comprising an actuator configured to cause the blade to rotate relative to the body and come into contact and cut the tether while the target object is secured in the plurality of fingers.

22. The tool of any of claims 1-4, wherein the plurality of fingers is arranged in an elongated rectangular configuration.

23. The tool of any of claims 1-4, wherein the plurality of fingers is arranged in an asymmetric cross pattern.

24. The tool of any of claims 1-4, further comprising a vision system configured to:
capture an image of the target object;
calculate a size of the target object from the image; and
determine if the target is ready for collection by comparing the calculated size to a threshold size.

25. The tool of claim 24, wherein the size is a length of the target object.

26. The tool of claim 24, wherein the size is a circumference of the target object.

27. The tool of claim 24, wherein the vision system is further configured to determine a location at which the tether should be cut based on an analysis of the image.

28. A method of collecting a target object utilizing the collection tool of any of the above claims, comprising:
enveloping the target object with the plurality of fingers on the collection tool;
grasping the target object with the plurality of fingers on the collection tool;
cutting the tether of the target object; and
removing the target object from a surrounding environment.

29. The method of claim 28, further comprising identifying and/or locating the target object.

30. The method of claim 28 or 29, further comprising assessing ripeness of the target object.

31. The method of claim 30, wherein the ripeness of the target object is assessed by a size of the target object.

32. The method of claim 31, wherein the size is a length of the target object.

33. The method of claim 31, wherein the size is a circumference of the target object.

34. The method of claim any one of claims 31-33, wherein the size of the target object is measured using a vision system comprising a camera.

35. The method of claim 34, wherein the measured size is compared to a predetermined threshold size.

36. The method of any one of claims 31-35, wherein an identified location and the measured size of the target object is used to determine a location for cutting the tether of the target object.

37. The method of any one of claims 28-36, wherein environmental obstructions are substantially avoided.

38. The method of any one of claims 28-37, wherein grasping of the target object is performed independently of cutting of the tether of the grasped target object.

39. The method of any one of claims 28-38, further comprising releasing and/or delivering the target object to a downstream process.

40. A collection system, comprising:
a robotic arm; and
the collection tool of any of claims 1-27 operatively attached to the robotic arm.

41. The system of claim 40, further comprising a controller programmable to operate the robotic arm and/or the collection tool.

42. The system of claim 40 or 41, further comprising a vision system programmable to identify and/or locate a target object by capturing an image of the target object.

43. The system of claim 42, wherein the vision system is further configured to calculate a size of the target object from the image.

44. The system of claim 42, wherein the vision system is further configured to determine if the target is ready for collection by comparing the calculated size to a threshold size.

45. The system of claim 44, wherein the size is a length of the target object.

46. The system of claim 44, wherein the size is a circumference of the target object.

47. The system of any one of claims 43-46, wherein the vision system is further configured to determine a location at which the tether should be cut based on an analysis of the image.

48. The system of any one of claims 40-47, wherein the robotic arm is further configured to release and/or deliver the target object to a downstream process.
